(19) United States
(12) Patent Application Publication
(10) Pub. No.: US 2026/0161739 A1
(43) Pub. Date: Jun. 11, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Yoshitaka NOZAKI, Tokyo (JP)

(73) Assignee: NEC Corporation, Tokyo (JP)

(21) Appl. No.: 19/401,561

(22) Filed: Nov. 26, 2025

(30) Foreign Application Priority Data
Dec. 6, 2024 (JP) 2024-213899

(51) Int. Cl. G06F 18/213; G06F 16/901; G06F 123/02; G06N 20/00

(52) U.S. Cl. CPC G06F 18/213; G06F 16/9024; G06N 20/00; G06F 2123/02

(57) ABSTRACT

An information processing apparatus including at least one processor and at least one memory, in which the at least one processor executes; acquisition processing of acquiring input data including multivariate time-series data regarding one or a plurality of subjects, structuring processing of generating structured data by graph structuring of the multivariate time-series data, calculation processing of calculating a feature vector of the one or the plurality of subjects by referring to at least the structured data, and prediction processing of performing prediction regarding the subject by referring to the feature vector, the at least one memory may store a program for causing the at least one processor to execute each type of the processing.

### INCORPORATION BY REFERENCE

This application is based upon and claims the benefit of priority from Japanese patent application No. 2024-213899, filed on Dec. 6, 2024, the disclosure of which is incorporated herein in its entirety by reference.

### TECHNICAL FIELD

The present disclosure relates to an information processing apparatus, an information processing method, and a non-transitory recording medium.

### BACKGROUND ART

There is known a technique called embedding propagation (EP) for learning embedding (vectorization) of data, an instance, or the like based on a graph structure representing a relationship between the data and the instance (Alberto Garcia-Duran and Mathias Niepert, “Learning Graph Representations with Embedding Propagation”, arXiv:1710.03059, October 2017).

There is also known a technique for performing outcome prediction of in-hospital mortality, the number of days in hospital, discharge destination, and the like of hospitalized patients by using embedding propagation (Brandon Malone, Alberto Garcia-Duran, and Mathias Niepert, “Learning Representations of Missing Data for Predicting Patient Outcomes”, arXiv:1811.04752, November 2018).

### SUMMARY

In addition to the above-described embedding propagation, a technique of performing prediction for a subject such as a patient often refers to a plurality of time-series data (also referred to as multivariate time-series data). On the other hand, the multivariate time-series data can include various time-series data having different acquisition frequencies. In a case where missing value interpolation is performed on such multivariate time-series data in time synchronization for, for example, each time-series data, an original data distribution is distorted due to a small number of valid values, and as a result, suitable prediction regarding the subject is hindered.

The present disclosure has been made in view of the above problem, and an example object of the present disclosure is to provide a technique capable of suitably executing prediction regarding a subject while referring to input data including multivariate time-series data.

An information processing apparatus according to an example aspect of the present disclosure includes an acquisition means for acquiring input data including multivariate time-series data regarding one or a plurality of subjects, a structuring means for generating structured data by graph structuring of the multivariate time-series data, a calculation means for calculating a feature vector of the one or the plurality of subjects by referring to at least the structured data, and a prediction means for performing prediction regarding the subject by referring to the feature vector.

An information processing method according to an example aspect of the present disclosure includes, by one or a plurality of processors, acquiring input data including multivariate time-series data regarding one or a plurality of subjects, generating structured data by graph structuring of the multivariate time-series data, calculating a feature vector of the one or the plurality of subjects by referring to at least the structured data, and performing prediction regarding the subject by referring to the feature vector.

A program according to an example aspect of the present disclosure is a program for causing a computer to function as an information processing apparatus, and causes the computer to function as an acquisition means for acquiring input data including multivariate time-series data regarding one or a plurality of subjects, a structuring means for generating structured data by graph structuring of the multivariate time-series data, a calculation means for calculating a feature vector of the one or the plurality of subjects by referring to at least the structured data, and a prediction means for performing prediction regarding the subject by referring to the feature vector.

According to an example aspect of the present disclosure, an example effect is provided that prediction regarding a subject can be suitably executed while referring to input data including multivariate time-series data.

### BRIEF DESCRIPTION OF DRAWINGS

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a diagram for describing processing in an information processing apparatus according to the present disclosure;

FIG. 5 is a diagram for describing processing in the information processing apparatus according to the present disclosure;

FIG. 6 is a block diagram illustrating a configuration example of the information processing apparatus according to the present disclosure;

FIG. 7 is a flowchart illustrating a flow of an information processing method according to the present disclosure;

FIG. 8 is a block diagram illustrating a configuration example of the information processing apparatus according to the present disclosure;

FIG. 9 is a flowchart illustrating a flow of an information processing method according to the present disclosure;

FIG. 10 is a diagram for describing processing in the information processing apparatus according to the present disclosure;

FIG. 11 is a block diagram illustrating a configuration example of the information processing apparatus according to the present disclosure;

FIG. 12 is a block diagram illustrating a configuration example of the information processing apparatus according to the present disclosure;

FIG. 13 is a block diagram illustrating a configuration of an information processing system according to the present disclosure; and

FIG. 14 is a block diagram illustrating a hardware configuration of the information processing apparatus according to the present disclosure.

### EXAMPLE EMBODIMENT

Hereinafter, example embodiments of the present disclosure will be exemplified. However, the present disclosure is not limited to the example embodiments described below, and various modifications can be made within the scope described in the claims. For example, example embodiments obtained by appropriately combining technical means adopted in the example embodiments described below can also be included in the scope of the present disclosure. Example embodiments obtained by appropriately omitting some of the technical means adopted in the example embodiments described below can also be included in the scope of the present disclosure. Effects mentioned in the example embodiments described below are examples of effects expected in the example embodiments, and do not define the extension of the present disclosure. That is, example embodiments that do not provide the effects mentioned in each of the example embodiments described below can also be included in the scope of the present disclosure.

### First Example Embodiment

A first example embodiment that is an example of the example embodiments of the present disclosure will be described in detail with reference to the drawings. The present example embodiment is a basic form of the example embodiments described below. An application range of each technical means adopted in the present example embodiment is not limited to the present example embodiment. That is, each technical means adopted in the present example embodiment can also be adopted in another example embodiment included in the present disclosure as long as no particular technical problem occurs. Each technical means illustrated in the drawings referred to for describing the present example embodiment can also be adopted in another example embodiment included in the present disclosure as long as no particular technical problem occurs.

### (Configuration of Information Processing Apparatus 1)

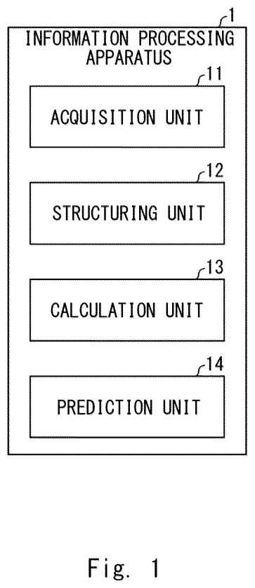

A configuration of an information processing apparatus 1 according to the present example embodiment will be described with reference to FIG. 1. FIG. 1 is a block diagram illustrating a configuration of the information processing apparatus 1. The information processing apparatus 1 can also be referred to as a prediction apparatus, a learning apparatus, or the like. As illustrated in FIG. 1, the information processing apparatus 1 includes an acquisition unit 11, a structuring unit 12, a calculation unit 13, and a prediction unit 14.

### (Acquisition Unit 11)

The acquisition unit 11 acquires input data including multivariate time-series data regarding one or a plurality of subjects. Here, the multivariate time-series data can include a plurality of time-series data, as an example. More specifically, the multivariate time-series data can include time-series data regarding a certain variate and time-series data regarding another variate. The number of time-series data included in the multivariate time-series data does not limit the present example embodiment.

### (Structuring Unit 12)

The structuring unit 12 generates structured data by graph structuring of the multivariate time-series data acquired by the acquisition unit 11. Here, “graph structuring” refers to, as an example, generating structured data in a graph format. The graph format refers to a data format including a plurality of nodes and one or a plurality of links (edges) connecting the nodes to each other. The structured data in a graph format may be referred to as graph structured data.

The structuring unit 12 may generate, as the structured data, a graph including nodes respectively corresponding to a plurality of data values included in the multivariate time-series data, and an edge weighted according to a time difference between the plurality of data values, as an example.

### (Calculation Unit 13)

The calculation unit 13 calculates a feature vector (also referred to as a feature value, or a feature value vector) of the one or the plurality of subjects by referring to at least the structured data generated by the structuring unit 12. Without limiting the present example embodiment, as an example, the calculation unit 13 specifically performs processing of
generating a graph (also referred to as a property graph, a patient graph, or the like.) including, as nodes, a plurality of patients including the one or the plurality of subjects by referring to attribute data of the one or the plurality of subjects included in the input data acquired by the acquisition unit 11, and
calculating the feature vector of the one or the plurality of subjects by referring to the generated graph. Here, the structured data may be referred to in the generation of the graph (property graph, patient graph), or the structured data may be referred to in the calculation of the feature vector.

The calculation unit 13 may be configured to calculate the feature vector of the one or the plurality of subjects by executing embedding propagation referring to the graph (property graph, patient graph). However, the example does not limit the present example embodiment.

### (Prediction Unit 14)

The prediction unit 14 performs prediction regarding the subject by referring to the feature vector calculated by the calculation unit 13. As an example, the prediction unit 14 may be configured to execute processing such as regression analysis or class classification by referring to the feature vector calculated by the calculation unit 13 and perform prediction regarding the subject by using a result of the processing. As an example, the prediction unit 14 may execute outcome prediction of in-hospital mortality, the number of days in hospital, discharge destination, and the like of the one or the plurality of subjects by referring to the feature vector. However, these examples do not limit the example embodiment.

### (Effect of Information Processing Apparatus 1)

As described above, the information processing apparatus 1,
a configuration is adopted in which
   input data is acquired including multivariate time-series data regarding one or a plurality of subjects,
   structured data is generated by graph structuring of the multivariate time-series data,
   a feature vector of the one or the plurality of subjects is calculated by referring to at least the structured data, and
   prediction regarding the subject is performed by referring to the feature vector. According to the above configuration, structured data is generated by graph structuring of the multivariate time-series data, a feature vector of the one or the plurality of subjects is calculated by referring to at least the structured data, and prediction regarding the subject is performed by referring to the feature vector. It is therefore possible to suitably execute the prediction regarding the subject while referring to the input data including the multivariate time-series data.

### (Flow of Information Processing Method S1)

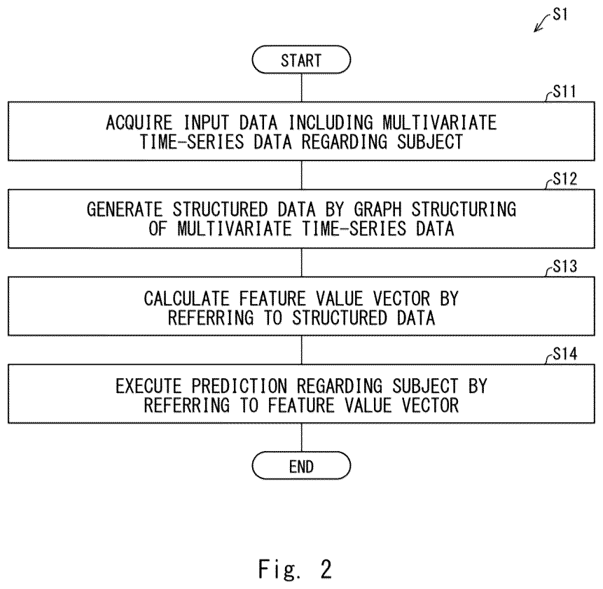

Subsequently, a flow of an information processing method S1 according to the present example embodiment will be described with reference to FIG. 2. FIG. 2 is a flowchart illustrating the flow of the information processing method S1. As illustrated in FIG. 2, the information processing method S1 includes a step (processing) S11 of acquiring input data, a step (processing) S12 of generating structured data, a step (processing) S13 of calculating a feature vector, and a step (processing) S14 of executing prediction.

### (Step S11)

In step S11, the acquisition unit 11 acquires input data including multivariate time-series data regarding one or a plurality of subjects. Since specific processing by the acquisition unit 11 has been described above, the description thereof will be omitted here.

### (Step S12)

Subsequently, in step S12, the structuring unit 12 generates structured data by graph structuring of the multivariate time-series data acquired by the acquisition unit 11 in step S11. Since specific processing by the structuring unit 12 has been described above, the description thereof will be omitted here.

### (Step S13)

Subsequently, in step S13, the calculation unit 13 calculates a feature vector of the one or the plurality of subjects by referring to at least the structured data generated by the structuring unit 12 in step S12. Since specific processing by the calculation unit 13 has been described above, the description thereof will be omitted here.

### (Step S14)

Subsequently, in step S14, the prediction unit 14 performs prediction regarding the subject by referring to the feature vector calculated by the calculation unit 13. Since specific processing by the prediction unit 14 has been described above, the description thereof will be omitted here.

### (Effect of Information Processing Method S1)

As described above, in the information processing method S1,
a configuration is adopted in which
   input data is acquired including multivariate time-series data regarding one or a plurality of subjects,
   structured data is generated by graph structuring of the multivariate time-series data,
   a feature vector of the one or the plurality of subjects is calculated by referring to at least the structured data, and
   prediction regarding the subject is performed by referring to the feature vector. According to the above configuration, an effect is provided similar to that of the information processing apparatus 1.

### Second Example Embodiment

A second example embodiment that is an example of the example embodiments of the present disclosure will be described in detail with reference to the drawings. Components having the same functions as the components described in the above-described example embodiment are denoted by the same reference signs, and the description thereof will be appropriately omitted. An application range of each of techniques adopted in the present example embodiment is not limited to the present example embodiment. That is, each technique adopted in the present example embodiment can also be adopted in another example embodiment included in the present disclosure within a range in which no particular technical problem occurs. Techniques illustrated in the drawings referred to for describing the present example embodiment can also be adopted in another example embodiment included in the present disclosure within a range in which no particular technical problem occurs.

### (Configuration of Information Processing System 100A)

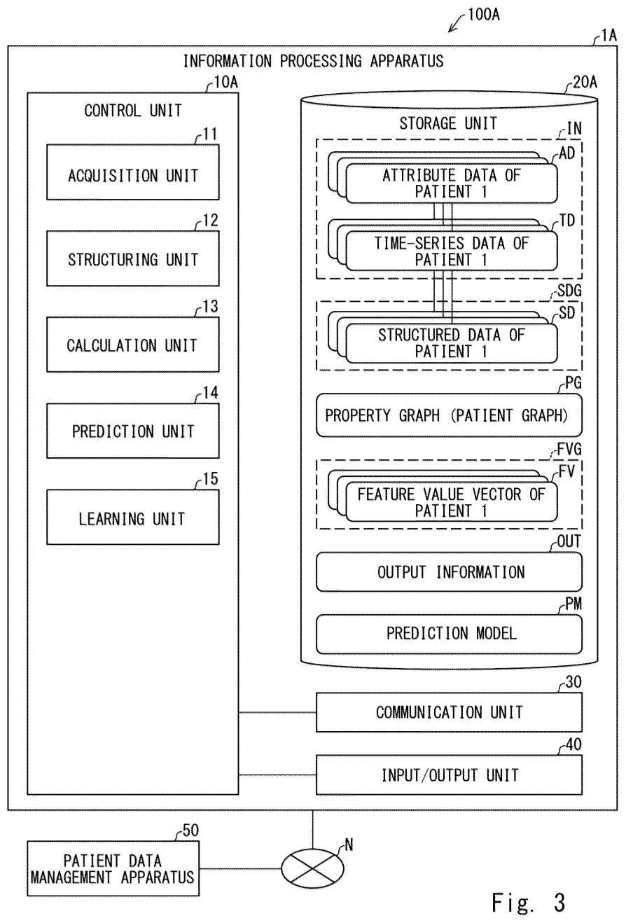

A configuration of an information processing system 100A according to the present example embodiment will be described with reference to FIG. 3. FIG. 3 is a block diagram illustrating the configuration of the information processing system 100A. As illustrated in FIG. 3, the information processing system 100A includes an information processing apparatus 1A and a patient data management apparatus 50 connected to the information processing apparatus 1A via a network N. Here, as a specific configuration of the network N, without limiting the present example embodiment, as an example, it is possible to use a wireless Local Area Network (LAN), a wired LAN, a Wide Area Network (WAN), a public line network, a mobile data communication network, or a combination of these networks.

In the present example embodiment, the patient data management apparatus 50 is described as an example of a configuration for providing input data including multivariate time-series data regarding one or a plurality of subjects to be described later, but this does not limit the present example embodiment, and another apparatus may be used as a configuration for providing the input data.

### (Patient Data Management Apparatus 50)

The patient data management apparatus 50 manages data including multivariate time-series data regarding one or a plurality of subjects. As an example, the patient data management apparatus 50 manages
multivariate time-series data regarding one or a plurality of subjects,
attribute data regarding one or a plurality of subjects,
and the like. Specific examples of the multivariate time-series data and the attribute data will be described later. As an example, a configuration may be made in which these data are included in the electronic medical records of the one or the plurality of subjects (patients) and the patient data management apparatus 50 is implemented as an electronic medical record management apparatus. The data managed by the patient data management apparatus 50 is referred to by the information processing apparatus 1A as input data IN to be described later.

### (Configuration of Information Processing Apparatus 1A)

Next, a configuration of the information processing apparatus 1A according to the present example embodiment will be described with reference to FIG. 3. FIG. 3 is a block diagram illustrating the configuration of the information processing apparatus 1A. As illustrated in FIG. 3, the information processing apparatus 1A includes a control unit 10A, a storage unit 20A, a communication unit 30, and an input/output unit 40. The information processing apparatus 1A can also be referred to as a prediction apparatus, a learning apparatus, or the like.

### (Communication Unit 30)

The communication unit 30 communicates with an apparatus on the outside of the information processing apparatus 1A via a network N. As an example, the communication unit 30 transmits data supplied from the control unit 10A to the apparatus on the outside, and supplies data received from the apparatus on the outside to the control unit 10A. More specifically, the communication unit 30 acquires, from the patient data management apparatus 50,
multivariate time-series data TD regarding one or a plurality of subjects, and
attribute data AD regarding one or a plurality of subjects, and stores the acquired data in the storage unit 20A.

### (Input/Output Unit 40)

The input/output unit 40 includes at least one of input/output devices such as a keyboard, mouse, a display, a printer, and a touch panel. Alternatively, the input/output unit 40 may be connected to an input/output device such as a keyboard, a mouse, a display, a printer, or a touch panel. In the case of this configuration, the input/output unit 40 receives inputs of various types of information to the information processing apparatus 1A from a connected input device. The input/output unit 40 outputs various types of information to a connected output device under the control of the control unit 10A. Examples of the input/output unit 40 include an interface such as, for example, a Universal Serial Bus (USB).

### (Storage Unit 20A)

The storage unit 20A stores various types of data referred to by the control unit 10A and various types of data generated by the control unit 10A. As an example, the storage unit 20A stores
input data IN,
structured data group SDG,
property graph PG,
feature vector group FVG,
output information OUT,
prediction model PM,
and the like.

Here, the input data IN includes
multivariate time-series data TD regarding a one or a plurality of subjects, and
attribute data AD regarding one or a plurality of subjects,
which are acquired from the patient data management apparatus 50. The multivariate time-series data TD may be simply referred to as time-series data TD.

The multivariate time-series data TD includes a plurality of time-series data. As an example, the plurality of time-series data includes measured values (data values) of a plurality of data items regarding one or a plurality of subjects (patients). For example, the data include time-series data of a body temperature change, a heart rate change, or the like during hospitalization of one or a plurality of subjects (patients).

More specifically, the multivariate time-series data TD regarding a subject 1 may include
measurement data of heart rate (HR) (also simply referred to as HR data) of the subject 1,
measurement data of platelets (also simply referred to as platelets data) of the subject 1,
measurement data of arterial carbon dioxide partial pressure (PaCO2) (also simply referred to as PaCO2 data) of the subject 1,
data of measurement of aspartate aminotransferase (AST) (also simply referred to as AST data) of the subject 1,
or the like. The multivariate time-series data TD regarding a subject 2 may include
HR data of the subject 2,
platelets data of the subject 2,
PaCO2 data of the subject 2,
AST data of the subject 2,
or the like. As an example, these data are measured at different timings or at different frequencies for respective subjects and data items.

The attribute data AD is data indicating an attribute of each subject, and includes, as an example, age, sex, disease name, and the like.

The structured data group SDG is data generated by the structuring unit 12 to be described later, and includes structured data SD regarding one or a plurality of subjects (patients). A specific example of the structured data SD will be described later.

The property graph PG is a graph generated by the calculation unit 13 to be described later referring to the structured data group SDG. The feature vector group FVG includes one or a plurality of feature vectors FV calculated by the calculation unit 13 referring to the property graph PG. The feature vector FV may also be referred to as a feature value FV or a feature value vector FV. Specific examples of the property graph PG and the feature vector FV will be described later.

The output information OUT includes a prediction result by the prediction unit 14 to be described later. A specific example of the output information OUT will be described later. The prediction model PM is a model used for prediction by the prediction unit 14, and is, as an example, a model to which the one or the plurality of feature vectors FV calculated by the calculation unit 13 is input and for executing outcome prediction for the subject. A specific example of the prediction model PM will be described later.

The prediction model PM is a model used by the prediction unit 14 to be described later, and is trained by the learning unit 15 as an example. A specific example of the prediction model PM will be described later.

### (Control Unit 10A)

As illustrated in FIG. 3, the control unit 10A includes the acquisition unit 11, the structuring unit 12, the calculation unit 13, the prediction unit 14, and the learning unit 15.

### (Acquisition Unit 11)

The acquisition unit 11 acquires the input data IN including the multivariate time-series data TD regarding one or a plurality of subjects. Since a specific example of the multivariate time-series data TD has been described above, redundant description will be omitted.

### (Structuring Unit 12)

The structuring unit 12 generates the structured data SD by graph structuring of the multivariate time-series data TD acquired by the acquisition unit 11. Here, “graph structuring” refers to, as an example, generating structured data in a graph format similarly to the first example embodiment, as an example. The graph format refers to a data format including a plurality of nodes and one or a plurality of links (edges) connecting the nodes to each other.

Here, the structuring unit 12 may generate, as the structured data SD, a directed graph including an oriented edge (directed edge) or an undirected graph including an unoriented edge (undirected edge). Some attribute value may be attached to each node or each edge. The structured data in a graph format may be referred to as graph structured data.

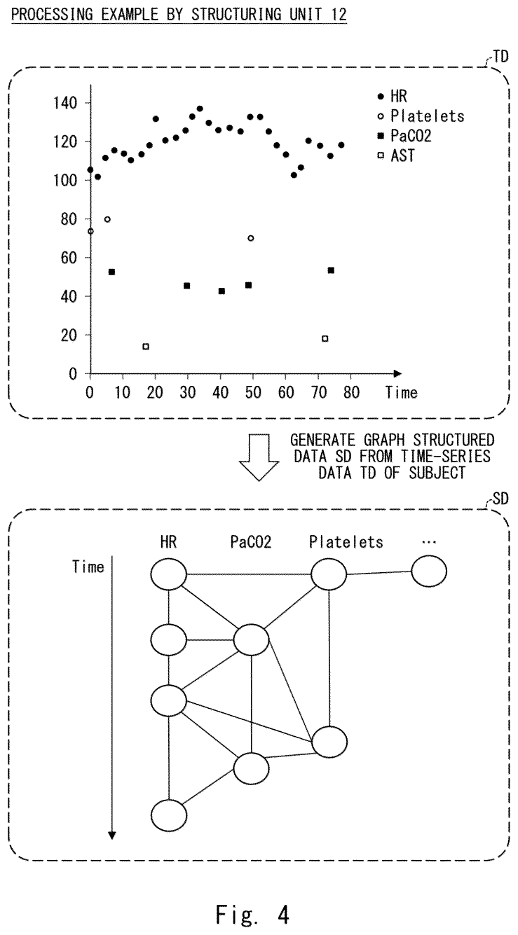

FIG. 4 is a diagram for describing a processing example by the structuring unit 12. The upper part of FIG. 4 illustrates the multivariate time-series data TD regarding a certain subject referred to by the structuring unit 12. As illustrated in the upper part of FIG. 4, the multivariate time-series data TD includes time-series data (HR data, Platelets data, PaCO2 data, AST data) of each data item described above as an example. As illustrated in the upper part of FIG. 4, these data items are measured at different timings or at different frequencies for respective data items.

The structuring unit 12 generates, as an example, the structured data SD illustrated in the lower part of FIG. 4 from the multivariate time-series data TD. As illustrated in the lower part of FIG. 4, the structured data SD generated by the structuring unit 12 includes a concept of passage of time, but the data items are not necessarily in time synchronization. Since the structured data SD generated by the structuring unit 12 has a very flexible data structure, as an example, the multivariate time-series data TD can be expressed as a graph including only valid values as nodes without taking each data item.

The structuring unit 12 may generate, as the structured data, a graph including nodes respectively corresponding to a plurality of data values included in the multivariate time-series data TD, and an edge weighted according to a time difference (difference in measurement time) between the plurality of data values. More specifically, in the example illustrated in the lower part of FIG. 4, each edge included in the structured data SD may be weighted according to the time difference (difference in measurement time) between the data values. A more specific processing example by the structuring unit 12 will be described later.

### (Calculation Unit 13)

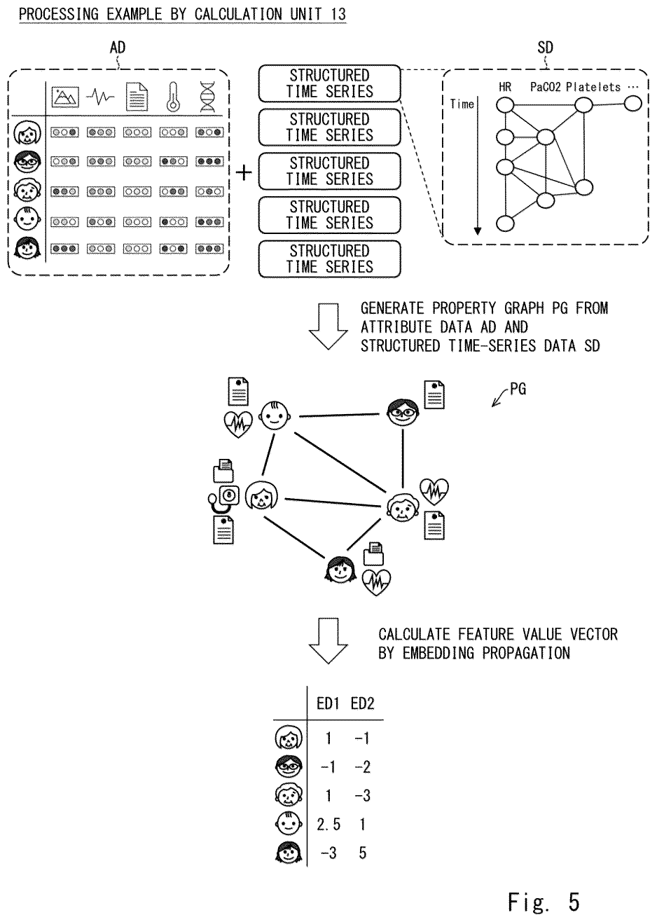

The calculation unit 13 calculates the feature vector FV of the one or the plurality of subjects by referring to at least the structured data SD generated by the structuring unit 12. FIG. 5 is a diagram for describing a processing example by the calculation unit 13.

As illustrated in FIG. 5, as an example, the calculation unit 13 generates the property graph (patient graph) PG by referring to
attribute data AD of one or a plurality of subjects (patients) included in the input data IN acquired by the acquisition unit 11, and
structured data SD of each subject generated by the structuring unit 12. Here, as an example, the property graph PG is a graph including
a plurality of nodes of the same type, each node having one or a plurality of attribute values, and
one or a plurality of links connecting the plurality of nodes to each other. More specifically, patients are associated with respective nodes, and the one or the plurality of attribute values can include an attribute value included in the attribute data AD.

Then, the calculation unit 13 calculates the feature vector FV of each of the one or the plurality of subjects by referring to the generated property graph (patient graph) PG. Here, without limiting the present example embodiment, as an example, a specific example of the calculation of the feature vector FV by referring to the property graph PG is executed by embedding propagation.

In the embedding propagation executed by the calculation unit 13, the feature value of each node included in the property graph PG is learned based on the graph structure of the property graph PG. In other words, in the embedding propagation, the manner of embedding each node included in the property graph PG into the feature space (vectorization and feature vector FV generation) is learned (unsupervised learning) based on the graph structure of the property graph PG. The relationship between the nodes in the property graph PG is taken over as it is in the embedding propagation, and the relationship between the instances (between the nodes) is held even in the learned embedded data. In the embedding propagation, a combination (in other words, multimodal data) of different expression formats such as categories, floats, free text, and images can be expressed in one consistent embedding space (feature space). In the embedding propagation, it is possible to generate a more beneficial embedding than a simple complementing method for a missing value.

### (Prediction Unit 14)

The prediction unit 14 performs prediction regarding the subject (patient) by referring to the feature vector FV calculated by the calculation unit 13. As an example, the prediction unit 14 inputs the feature vector FV calculated by the calculation unit 13 to the learned prediction model PM, and performs prediction regarding the subject (patient) by using output of the prediction model PM.

As an example, the prediction unit 14 may be configured to execute processing such as regression analysis and class classification by the prediction model PM referring to the feature vector FV calculated by the calculation unit 13, and perform prediction regarding the subject by using a result of the processing. As an example, the prediction unit 14 may execute outcome prediction of in-hospital mortality, the number of days in hospital, discharge destination, and the like of the one or the plurality of subjects by the prediction model PM referring to the feature vector FV. Prediction results of these can include information for assisting decision making of a user (doctor, medical worker, or the like). Thus, it may be expressed that the prediction unit 14 performs outcome prediction regarding the subject (patient) in order to assist the decision making of the user (doctor, medical worker, or the like).

### (Learning Unit 15)

The learning unit 15 trains the prediction model PM used by the prediction unit 14. As an example, the learning unit 15 causes the prediction model PM to perform machine learning by referring to training data including the feature vector FV and a ground truth label attached to the feature vector FV.

As described above, in the information processing apparatus 1A,
a configuration is adopted in which
   input data IN is acquired including multivariate time-series data TD regarding one or a plurality of subjects,
   structured data SD is generated by graph structuring of the multivariate time-series data TD,
   a feature vector FV of the one or the plurality of subjects is calculated by referring to at least the structured data SD, and
   prediction regarding the subject is performed by referring to the feature vector FV. According to the above configuration, structured data is generated by graph structuring of the multivariate time-series data, a feature vector of the one or the plurality of subjects is calculated by referring to at least the structured data, and prediction regarding the subject is performed by referring to the feature vector. It is therefore possible to suitably execute the prediction regarding the subject while referring to the input data including the multivariate time-series data.

In particular, in the medical field, time-series data tends to be irregularly sampled and very sparse, and if missing value interpolation is performed in time synchronization for each time-series data as in the conventional technique, an original data distribution may be distorted due to a small number of valid values. In the information processing apparatus 1A configured as described above, since the multivariate time-series data is subjected to graph-based structuring and then referred to in the calculation of the feature vector FV, such a problem of distortion of the data distribution can be suppressed.

The information processing apparatus 1A calculates the feature vector FV by using embedding propagation, as an example. The structured data SD obtained by graph-based structuring of the multivariate time-series data as described above can be suitably referred to in embedding propagation as one of multimodal data.

As described above, according to the information processing apparatus 1A, multimodal data processing including the multivariate time-series data can be suitably executed, and prediction regarding the subject can be suitably executed.

### Specific Configuration Example 1

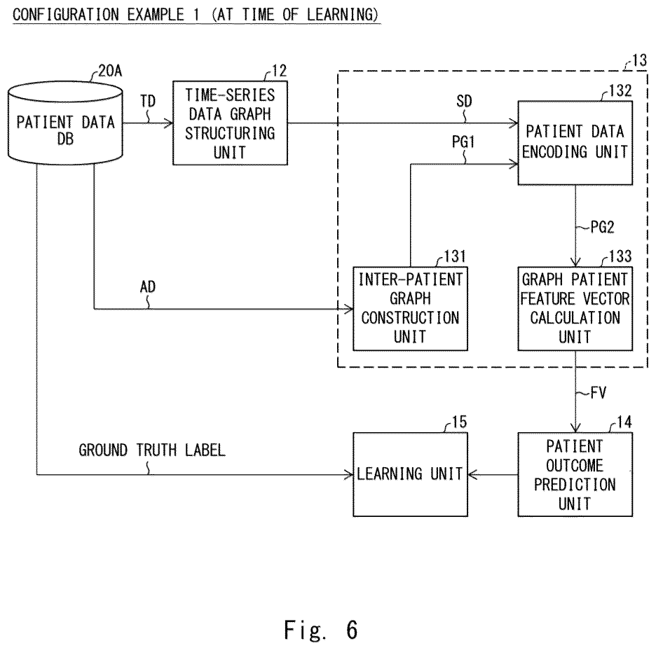

Hereinafter, a more specific configuration example 1 of the information processing apparatus 1A will be described with reference to FIG. 6. The present example is a configuration example in a learning phase of the information processing apparatus 1A. However, this does not limit the present example.

As illustrated in FIG. 6, first, the multivariate time-series data TD regarding one or a plurality of patients is supplied from a patient data DB (storage unit 20A) to a time-series data graph structuring unit 12 (the structuring unit 12 described above). The time-series data graph structuring unit 12 generates the structured data SD of each patient by graph structuring of the multivariate time-series data TD of each patient, and supplies the generated structured data SD to the calculation unit 13.

Here, in the present example, the calculation unit 13 includes an inter-patient graph construction unit (patient graph generation unit) 131, a patient data encoding unit 132, and a graph patient feature vector calculation unit 133. The structured data SD of each patient generated by the time-series data graph structuring unit 12 is supplied to the patient data encoding unit 132.

On the other hand, the inter-patient graph construction unit 131 acquires the attribute data AD regarding the one or the plurality of patients from the patient data DB (storage unit 20A), and generates a first inter-patient graph (first patient graph, first property graph) PG1 by referring to the acquired attribute data AD.

Here, as an example, the patient graph PG1 is a graph including
a plurality of nodes of the same type, each node having one or a plurality of attribute values, and
one or a plurality of links connecting the plurality of nodes to each other. More specifically, patients are associated with respective nodes, and the one or the plurality of attribute values can include an attribute value included in the attribute data AD. The first patient graph PG1 generated by the inter-patient graph construction unit 131 is supplied to the patient data encoding unit 132.

Without limiting the present example, as an example, specific processing of generating the patient graph by the inter-patient graph construction unit 131 may be configured to construct a patient graph with edges stretched between similar patients by kNN clustering by using the attribute data AD of the patient.

The patient data encoding unit 132 encodes the structured data SD of each patient generated by the structuring unit 12 and the first patient graph PG1 generated by the inter-patient graph construction unit 131.

Without limiting the present example, as a specific configuration of the patient data encoding unit 132, a configuration is adopted by which graph data can be encoded, such as a Graph Neural Network (GNN) or a Graph Convolutional Network (GCN). In the encoded patient graph, each node is accompanied by an encoded attribute value and encoded structured data SD. The encoded patient graph is also referred to as a second patient graph PG2 or a second property graph PG2.

The graph patient feature vector calculation unit 133 calculates the feature vector FV of each patient by referring to the second patient graph PG2 generated by the patient data encoding unit 132. As an example, the graph patient feature vector calculation unit 133 calculates the feature vector FV of each patient by executing the above-described embedding propagation.

The patient data encoding unit 132 and the graph patient feature vector calculation unit 133 may be collectively expressed as a feature vector calculation unit. It can be expressed that the feature vector calculation unit is configured to calculate the feature vector of the one or the plurality of patients by referring to the structured data SD and the patient graph (the first patient graph PG1 or the second patient graph PG2).

A patient outcome prediction unit 14 (the prediction unit 14 described above) refers to the feature vector FV of one or a plurality of patients, and executes outcome prediction regarding the patient by using the prediction model PM.

The prediction result by the prediction unit 14 is supplied to the learning unit 15.

The learning unit 15 performs machine learning of the prediction model PM by referring to the ground truth label regarding the one or the plurality of subjects and the prediction result by the prediction unit 14. More specifically, the learning unit 15 updates parameters of the prediction model PM so that the prediction result by the prediction unit 14 approaches the ground truth label. The updated parameters are stored in the storage unit 20A.

### Specific Processing Example 1

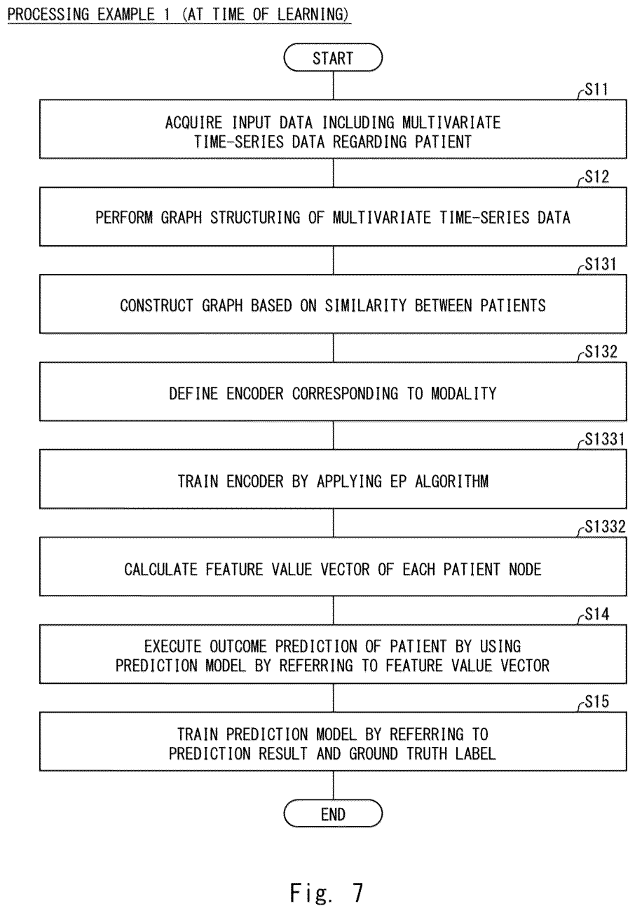

Subsequently, a more specific processing example 1 by the information processing apparatus 1A will be described with reference to FIG. 7. The present example is a processing example corresponding to the configuration example 1 described above, and is a processing example in the learning phase of the information processing apparatus 1A. However, this does not limit the present example. FIG. 7 is a flowchart illustrating a flow of processing according to the present example.

### (Step S11)

First, in step S11, the acquisition unit 11 acquires the input data IN including the multivariate time-series data TD regarding one or a plurality of patients. The acquired input data IN is referred to by the time-series data graph structuring unit 12 (structuring unit 12) and the calculation unit 13.

### (Step S12)

Subsequently, in step S12, the time-series data graph structuring unit 12 (structuring unit 12) generates the structured data SD of each patient by graph structuring of the multivariate time-series data TD of each patient.

### (Step S131)

Subsequently, in step S131, the inter-patient graph construction unit 131 refers to the attribute data AD of each patient included in the input data IN, and generates a graph (first patient graph PG1) based on the similarity between the patients.

### (Step S132)

Subsequently, in step S132, the patient data encoding unit 132 defines an encoder corresponding to a modality of data to be referred to. As an example, the patient data encoding unit 132 defines an encoder corresponding to the attribute data AD and the structured data SD. Then, the patient data encoding unit 132 generates the second patient graph PG2 by encoding the attribute data AD and the structured data SD by using the defined encoder.

### (Step S1331)

Subsequently, in step S1331, the graph patient feature vector calculation unit 133 trains the encoder by executing embedding propagation. The training may be repeated a plurality of times. Then, the graph patient feature vector calculation unit 133 updates the second patient graph PG2 by using the trained encoder.

### (Step S1332)

Subsequently, in step S1332, the graph patient feature vector calculation unit 133 calculates a feature vector of one or a plurality of patients by referring to the updated second patient graph PG2.

### (Step S14)

Subsequently, in step S14, the patient outcome prediction unit 14 (prediction unit 14) refers to the feature vector FV of one or a plurality of patients, and executes outcome prediction regarding the patient by using the prediction model PM.

### (Step S15)

Subsequently, in step S15, machine learning of the prediction model PM is performed by referring to the ground truth label regarding the one or the plurality of subjects and the prediction result by the prediction unit 14. The parameters of the learned prediction model PM are stored in the storage unit 20A.

### (Specific Configuration Example 2 (at Time of Inference))

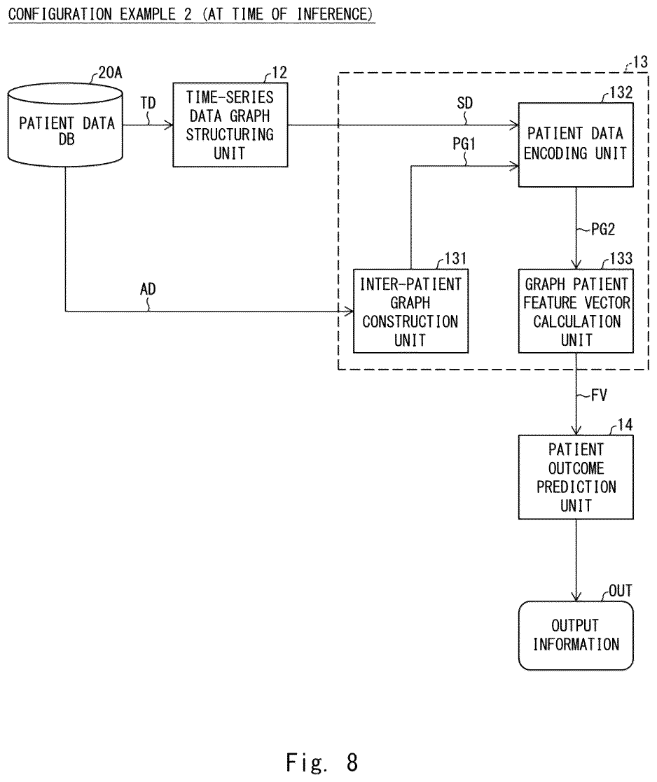

Subsequently, a more specific configuration example 2 of the information processing apparatus 1A will be described with reference to FIG. 8. The present example is a configuration example in an inference phase of the information processing apparatus 1A. However, this does not limit the present example.

As illustrated in FIG. 8, the present configuration example is different from the configuration example 1 described above in that the learning unit 15 is not provided, and the configuration other than that is similar to the configuration example 1 described above. In the present example, the time-series data graph structuring unit 12 (structuring unit 12) refers to the time-series data TD regarding a patient to be predicted. In the present example, the inter-patient graph construction unit 131 refers to the attribute data AD regarding the patient to be predicted. Then, the patient outcome prediction unit 14 (prediction unit 14) executes outcome prediction regarding the patient to be predicted using the above-described learned prediction model PM.

### Specific Processing Example 2

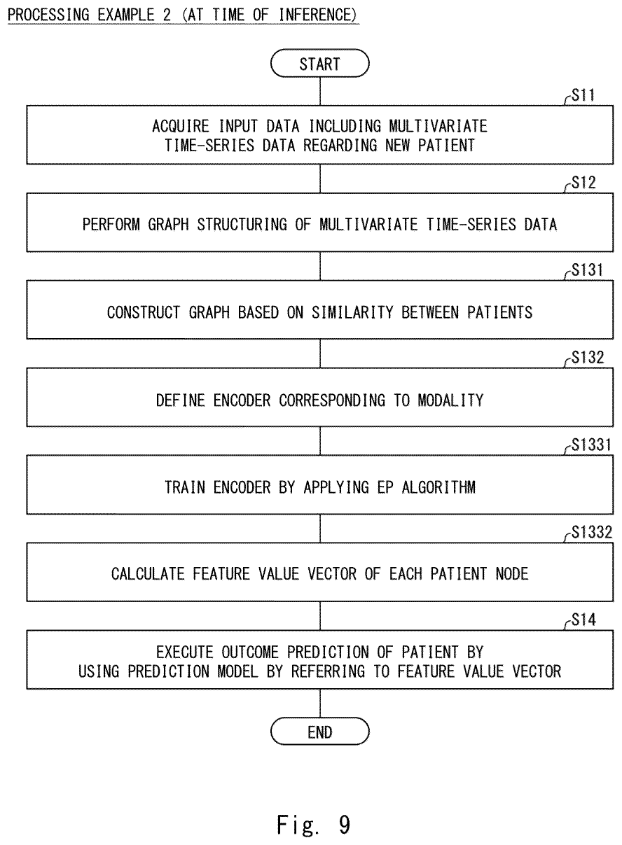

Subsequently, a more specific processing example 2 by the information processing apparatus 1A will be described with reference to FIG. 9. The present example is a processing example corresponding to the second configuration example described above, and is a processing example in the inference phase of the information processing apparatus 1A. However, this does not limit the present example. FIG. 9 is a flowchart illustrating a flow of processing according to the present example.

### (Step S11)

First, in step S11, the acquisition unit 11 acquires the input data IN including the multivariate time-series data TD regarding a new patient (patient to be predicted). The acquired input data IN is referred to by the time-series data graph structuring unit 12 (structuring unit 12) and the calculation unit 13.

### (Steps S12 to S1332)

Since the processing in steps S12 to S1332 is similar to that in the processing example 1, redundant description will be omitted.

### (Step S14)

In step S14, the patient outcome prediction unit 14 (prediction unit 14) refers to the feature vector FV of one or a plurality of patients, and executes outcome prediction regarding the patient by using the learned prediction model PM.

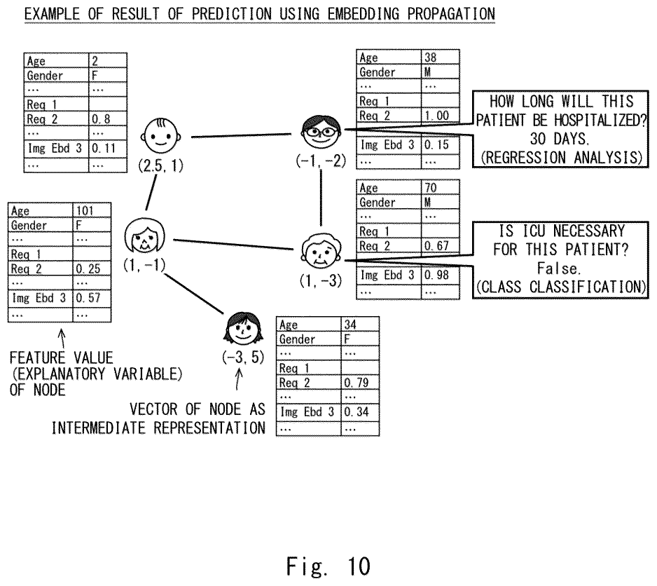

FIG. 10 is a diagram illustrating an example of prediction executed in step S14. In the example illustrated in FIG. 10, the patient outcome prediction unit 14 executes regression analysis by referring to the feature vector FV to perform prediction of the number of days of hospitalization (number of days in hospital) regarding a certain patient. In the example illustrated in FIG. 10, class classification is executed by referring to the feature vector FV, and necessity of an ICU is predicted for another patient. These predictions are an example of the outcome prediction regarding one or a plurality of patients.

More specifically, the information processing apparatus 1A acquires an instruction (query) to perform prediction regarding the number of days of hospitalization of a certain patient from the user via the input/output unit 40, refers to the attribute data AD and the time-series data TD of the certain patient, based on the instruction, and executes the embedding propagation by the above-described processing. Then, by regression analysis referring to the feature vector of the certain patient, the patient outcome prediction unit 14 performs prediction regarding the number of days of hospitalization of the certain patient.

In the example illustrated in FIG. 10, “30 days” is derived as the prediction regarding the number of days of hospitalization of the certain patient. The information processing apparatus 1A may visually present a result of the prediction to the user via the input/output unit 40. For example, the output information OUT such as

“A predicted value of the number of days of hospitalization of a patient A is 30 days”
may be displayed on the display of the input/output unit 40.

As another example, the information processing apparatus 1A acquires an instruction (query) to perform prediction regarding the necessity of the ICU for a certain patient from the user via the input/output unit 40, refers to the attribute data AD and the time-series data TD of the certain patient, based on the instruction, and executes the embedding propagation by the above-described processing. Then, by class classification referring to the feature vector of the certain patient, the patient outcome prediction unit 14 performs prediction regarding the necessity of the ICU for the certain patient. In the example illustrated in FIG. 10, “False (unnecessary)” is derived as prediction regarding the necessity of the ICU for the certain patient. The information processing apparatus 1A may visually present a result of the prediction to the user via the input/output unit 40. For example, the output information OUT such as
“We predict that the ICU is unnecessary for a patient B” may be displayed on the display of the input/output unit 40.

### (Specific Configuration Example 3 (at Time of Learning))

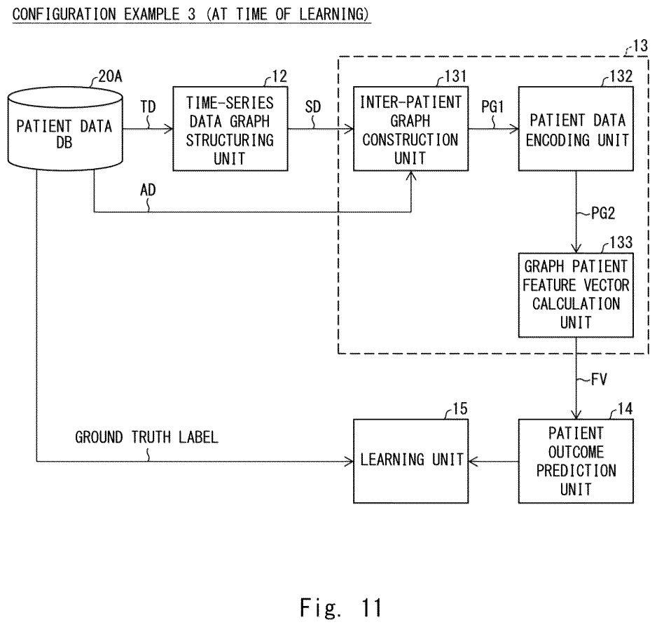

Hereinafter, a specific configuration example 3 of the information processing apparatus 1A will be described with reference to FIG. 11. The present example is a configuration example in the learning phase of the information processing apparatus 1A. However, this does not limit the present example.

As illustrated in FIG. 11, the configuration according to the present example is different from the configuration example 1 described above in a flow of data regarding the calculation unit 13, and is similar to that of the configuration example 1 except for this. Hereinafter, the difference from the configuration example 1 will be mainly described, and the description overlapping with the configuration example 1 may be omitted.

As illustrated in FIG. 11, in the present example, first, the multivariate time-series data TD regarding one or a plurality of patients is supplied from the patient data DB (storage unit 20A) to the time-series data graph structuring unit 12 (the structuring unit 12 described above). The time-series data graph structuring unit 12 generates the structured data SD of each patient by graph structuring of the multivariate time-series data TD of each patient, and supplies the generated structured data SD to the inter-patient graph construction unit 131.

On the other hand, the inter-patient graph construction unit 131 acquires the attribute data AD regarding the one or the plurality of patients from the patient data DB (storage unit 20A), and generates the first inter-patient graph (first patient graph, first property graph) PG1 by referring to the acquired attribute data AD and the structured data SD.

The patient data encoding unit 132 encodes the structured data SD of each patient generated by the structuring unit 12 and the first patient graph PG1 generated by the inter-patient graph construction unit 131.

Also in the present example, the encoded patient graph is referred to as the second patient graph PG2 or the second property graph PG2.

The graph patient feature vector calculation unit 133, the patient outcome prediction unit 14 (prediction unit 14), and the learning unit 15 are similar to those of the configuration example 1, and thus redundant description will be omitted.

### (Specific Configuration Example 4 (at Time of Inference))

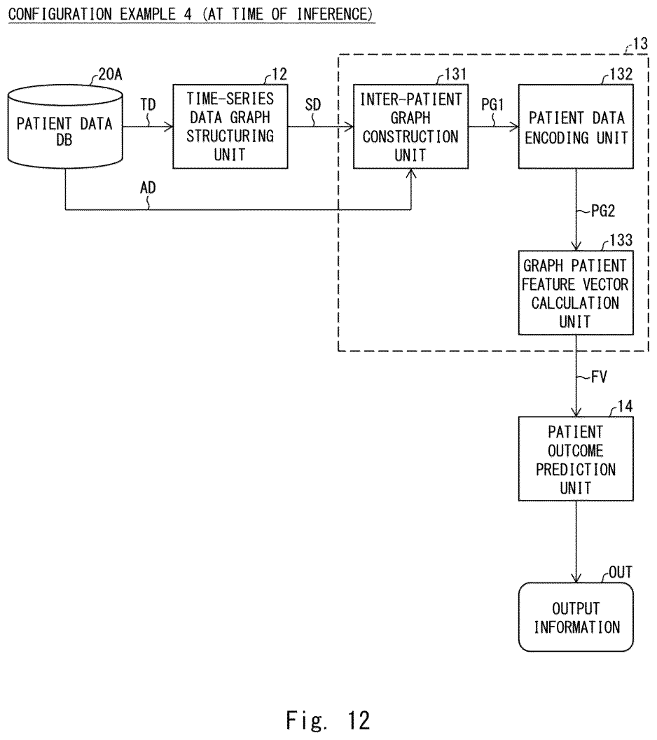

Subsequently, a more specific configuration example 4 of the information processing apparatus 1A will be described with reference to FIG. 12. The present example is a configuration example in the inference phase of the information processing apparatus 1A. However, this does not limit the present example.

As illustrated in FIG. 12, the present configuration example is different from the configuration example 3 described above in that the learning unit 15 is not provided, and the configuration other than that is similar to the configuration example 3 described above. In the present example, the time-series data graph structuring unit 12 (structuring unit 12) refers to the time-series data TD regarding a patient to be predicted. In the present example, the inter-patient graph construction unit 131 refers to the attribute data AD regarding the patient to be predicted. Then, the patient outcome prediction unit 14 (prediction unit 14) executes outcome prediction regarding the patient to be predicted using the above-described learned prediction model PM.

### (Supplementary Notes Regarding Structuring Unit 12)

A more specific processing example regarding the structuring unit 12 (time-series data graph structuring unit 12) will be described. As described above, the structuring unit 12 generates the graph structured data SD (hereinafter also simply referred to as a graph) including a plurality of nodes and one or a plurality of links (edges) connecting the nodes to each other. Here, as an example, each node represents a measurement event for each time, and each node is accompanied by a sensor value and a sensor type. On the other hand, the edge is set under a certain rule as an example. Here, examples of the rule include
an edge is stretched to sensor value nodes in a fixed time window
an edge with a weight is stretched by use of the weight inversely proportional to a measurement interval
an edge according to the sensor type may be connected or deleted based on domain knowledge in the medical field (for example, connection of the edge is performed with sensor measurement values related to the circulatory system as a group, and the edge is not connected to another system).

The structuring unit 12 may be configured to generate the graph in a data-driven manner by using a predetermined algorithm (as an example, RAINDROP algorithm or the like).

### Third Example Embodiment

A third example embodiment that is an example of the example embodiments of the present disclosure will be described in detail with reference to the drawings. Components having the same functions as the components described in the above-described example embodiment are denoted by the same reference signs, and the description thereof will be appropriately omitted. An application range of each of techniques adopted in the present example embodiment is not limited to the present example embodiment. That is, each technique adopted in the present example embodiment can also be adopted in another example embodiment included in the present disclosure within a range in which no particular technical problem occurs. Techniques illustrated in the drawings referred to for describing the present example embodiment can also be adopted in another example embodiment included in the present disclosure within a range in which no particular technical problem occurs.

### (Configuration of Information Processing System 100B)

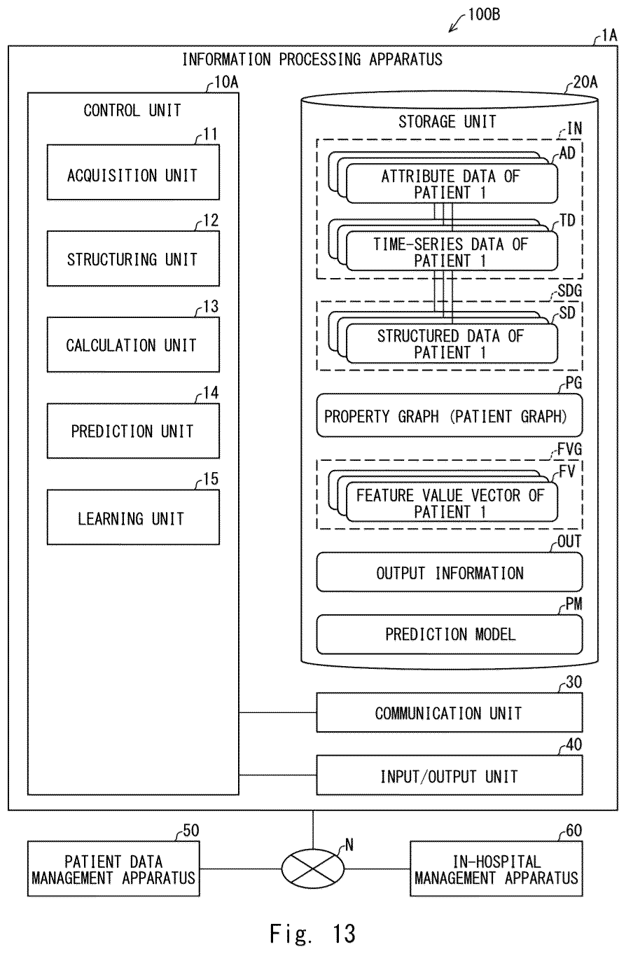

A configuration of an information processing system 100B according to the present example embodiment will be described with reference to FIG. 13. FIG. 13 is a block diagram illustrating the configuration of the information processing system 100B. As illustrated in FIG. 13, the information processing system 100B includes the information processing apparatus 1A, and the patient data management apparatus 50 and an in-hospital management apparatus 60 connected to the information processing apparatus 1A via the network N. The information processing apparatus 1A and the patient data management apparatus 50 are similar to those of the second example embodiment, and redundant description is omitted since they have already been described.

The in-hospital management apparatus 60 performs management (optimization of a use schedule) of hospital beds and the ICU, and stock management, order proposal, and the like of medicine and the like.

The information processing apparatus 1A executes outcome prediction regarding one or a plurality of patients by executing the processing described in the second example embodiment, and the in-hospital management apparatus 60 refers to the outcome prediction to perform management of the hospital beds, the ICU, the medicine, or the like related to the one or the plurality of patients.

As an example, in a case where the information processing apparatus 1A performs prediction that the use of the ICU is unnecessary as the outcome prediction of a certain patient and the in-hospital management apparatus 60 acquires a result of the prediction, the in-hospital management apparatus 60 may execute optimization of the use schedule of the hospital beds and the ICU, based on the result of the prediction. Then, the in-hospital management apparatus 60 may visually present output information based on an execution result of the optimization to the user (doctor or medical worker). In such presentation, advice (for example, a proposal such as “Since there is a vacancy in the usage status of the ICU, how about moving a patient C to the ICU?”) for assisting decision making of the user may be included in the output information.

As an example, in a case where the information processing apparatus 1A performs prediction of a risk of occurrence of a pressure ulcer as the outcome prediction of a certain patient and the in-hospital management apparatus 60 acquires a result of the prediction, the in-hospital management apparatus 60 may perform control to optimize a pressure distribution of an air mattress for pressure ulcer prevention, based on the result of the prediction.

In addition, as an example, in a case where the information processing apparatus 1A performs prediction of a pneumonia risk as the outcome prediction of a certain patient and the in-hospital management apparatus 60 acquires a result of the prediction, the in-hospital management apparatus 60 may perform control to optimize angle adjustment of an electric bed, based on the result of the prediction.

### [Example of Implementation by Software]

Some or all of the functions of the information processing apparatuses 1 and 1A (hereinafter, also referred to as “each of the above apparatuses”) may be implemented by hardware such as an integrated circuit (IC chip) or may be implemented by software.

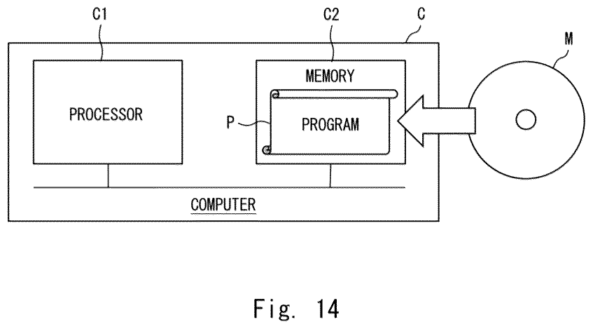

For the latter, each of the above apparatuses is implemented by a computer that executes a command of a program that is software for implementing each function, for example. An example of such a computer (hereinafter, referred to as a computer C) is illustrated in FIG. 14. FIG. 14 is a block diagram illustrating a hardware configuration of the computer C functioning as each of the above apparatuses.

The computer C includes at least one processor C1 and at least one memory C2. A program P for causing the computer C to operate as each of the above apparatuses is recorded in the memory C2. The processor C1 in the computer C reads out the program P from the memory C2 and executes the program P to implement each function of each of the above apparatuses.

Available examples of the processor C1 include a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, and a combination thereof. Available examples of the memory C2 include a flash memory, a Hard Disk Drive (HDD), a Solid State Drive (SSD), and a combination thereof.

The computer C may further include a Random Access Memory (RAM) for expanding the program P at the time of execution and temporarily storing various types of data. The computer C may further include a communication interface for sending and receiving data to and from another apparatus. The computer C may further include an input/output interface for connecting input/output devices such as a keyboard, a mouse, a display, and a printer.

The program P can be recorded in a tangible recording medium M that is non-transitory and readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### [Supplementary Note A]

The present disclosure includes the techniques described in the following supplementary notes. However, the present disclosure is not limited to the techniques described in the following supplementary notes, and various modifications can be made within the scope described in the claims.

### (Supplementary Note A1)

An information processing apparatus including
an acquisition means for acquiring input data including multivariate time-series data regarding one or a plurality of subjects,
a structuring means for generating structured data by graph structuring of the multivariate time-series data,
a calculation means for calculating a feature vector of the one or the plurality of subjects by referring to at least the structured data, and
a prediction means for performing prediction regarding the subject by referring to the feature vector.

### (Supplementary Note A2)

The information processing apparatus according to Supplementary Note A1, in which
the input data includes attribute data of the one or the plurality of subjects, and
the calculation means includes
a patient graph generation means for generating a patient graph including, as nodes, a plurality of patients including the one or the plurality of subjects, by referring to the attribute data, and
a feature vector calculation means for calculating the feature vector of the one or the plurality of subjects by referring to the structured data and the patient graph.

### (Supplementary Note A3)

The information processing apparatus according to Supplementary Note A2, in which
the feature vector calculation means
generates encoded data by encoding the structured data and data included in the patient graph, and
calculates the feature vector of the one or the plurality of subjects by referring to the encoded data.

### (Supplementary Note A4)

The information processing apparatus according to Supplementary Note A1, in which
the input data includes attribute data of the one or the plurality of subjects, and
the calculation means includes
a patient graph generation means for generating a patient graph including, as nodes, a plurality of patients including the one or the plurality of subjects, by referring to the attribute data and the structured data, and
a feature vector calculation means for calculating the feature vector of the one or the plurality of subjects by referring to the patient graph.

### (Supplementary Note A5)

The information processing apparatus according to any one of Supplementary Notes A2 to A4, in which
the structuring means
generates, as the structured data, a graph including
nodes respectively corresponding to a plurality of data values included in the multivariate time-series data, and
an edge weighted according to a time difference between the plurality of data values.

### (Supplementary Note A6)

The information processing apparatus according to Supplementary Note A5, in which the feature vector calculation means calculates the feature vector of the one or the plurality of subjects by executing embedding propagation referring to at least the patient graph.

### (Supplementary Note A7)

The information processing apparatus according to any one of Supplementary Notes A1 to A6, in which the prediction means performs outcome prediction regarding the subject in order to assist decision making of a user.

### (Supplementary Note A8)

The information processing apparatus according to any one of Supplementary Notes A1 to A7, further including a learning means for causing the prediction means to perform machine learning referring to training data including a feature vector and a ground truth label attached to the feature vector.

### [Supplementary Note B]

The present disclosure includes the techniques described in the following supplementary notes. However, the present disclosure is not limited to the techniques described in the following supplementary notes, and various modifications can be made within the scope described in the claims.

### (Supplementary Note B1)

An information processing method including
acquisition processing of acquiring input data including multivariate time-series data regarding one or a plurality of subjects, by at least one processor,
structuring processing of generating structured data by graph structuring of the multivariate time-series data, by the at least one processor,
calculation processing of calculating a feature vector of the one or the plurality of subjects by referring to at least the structured data, by the at least one processor, and
prediction processing of performing prediction regarding the subject by referring to the feature vector, by the at least one processor.

### (Supplementary Note B2)

The information processing method according to Supplementary Note B1, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data, and
feature vector calculation processing of calculating the feature vector of the one or the plurality of subjects by referring to the structured data and the patient graph.

### (Supplementary Note B3)

The information processing method according to Supplementary Note B2, in which
in the feature vector calculation processing, the at least one processor
generates encoded data by encoding the structured data and data included in the patient graph, and
calculates the feature vector of the one or the plurality of subjects by referring to the encoded data.

### (Supplementary Note B4)

The information processing method according to Supplementary Note B1, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data and the structured data, and
feature vector calculation processing of calculating the feature vector of the one or the plurality of subjects by referring to the patient graph.

### (Supplementary Note B5)

The information processing method according to any one of Supplementary Notes B2 to B4, in which
in the structuring processing, the at least one processor
generates, as the structured data, a graph including
nodes respectively corresponding to a plurality of data values included in the multivariate time-series data, and
an edge weighted according to a time difference between the plurality of data values.

### (Supplementary Note B6)

The information processing method according to Supplementary Note B5, in which in the feature vector calculation processing, the at least one processor calculates the feature vector of the one or the plurality of subjects by executing embedding propagation referring to at least the patient graph.

### (Supplementary Note B7)

The information processing method according to any one of Supplementary Notes B1 to B6, in which in the prediction processing, the at least one processor performs outcome prediction regarding the subject in order to assist decision making of a user.

### (Supplementary Note B8)

The information processing method according to any one of Supplementary Notes B1 to B7, further including learning processing of causing the prediction processing to perform machine learning referring to training data including a feature vector and a ground truth label attached to the feature vector, by the at least one processor.

### [Supplementary Note C]

The present disclosure includes the techniques described in the following supplementary notes. However, the present disclosure is not limited to the techniques described in the following supplementary notes, and various modifications can be made within the scope described in the claims.

### (Supplementary Note C1)

An information processing program for causing a computer to function as an information processing apparatus,
the information processing program causing the computer to function as
an acquisition means for acquiring input data including multivariate time-series data regarding one or a plurality of subjects,
a structuring means for generating structured data by graph structuring of the multivariate time-series data,
a calculation means for calculating a feature vector of the one or the plurality of subjects by referring to at least the structured data, and
a prediction means for performing prediction regarding the subject by referring to the feature vector.

### (Supplementary Note C2)

The information processing program according to Supplementary Note C1, in which
the input data includes attribute data of the one or the plurality of subjects, and
the calculation means executes
patient graph generation processing of generating a patient graph including, as nodes, a plurality of patients including the one or the plurality of subjects, by referring to the attribute data, and
feature vector calculation processing of calculating the feature vector of the one or the plurality of subjects by referring to the structured data and the patient graph.

### (Supplementary Note C3)

The information processing program according to Supplementary Note C2, in which
the feature vector calculation means
generates encoded data by encoding the structured data and data included in the patient graph, and
calculates the feature vector of the one or the plurality of subjects by referring to the encoded data.

### (Supplementary Note C4)

The information processing program according to Supplementary Note C1, in which
the input data includes attribute data of the one or the plurality of subjects, and
the calculation means executes
patient graph generation processing of generating a patient graph including, as nodes, a plurality of patients including the one or the plurality of subjects, by referring to the attribute data and the structured data, and
feature vector calculation processing of calculating the feature vector of the one or the plurality of subjects by referring to the patient graph.

### (Supplementary Note C5)

The information processing program according to any one of Supplementary Notes C2 to C4, in which
the structuring means
generates, as the structured data, a graph including
nodes respectively corresponding to a plurality of data values included in the multivariate time-series data, and
an edge weighted according to a time difference between the plurality of data values.

### (Supplementary Note C6)

The information processing program according to Supplementary Note C5, in which the feature vector calculation means calculates the feature vector of the one or the plurality of subjects by executing embedding propagation referring to at least the patient graph.

### (Supplementary Note C7)

The information processing program according to any one of Supplementary Notes C1 to C6, in which the prediction means performs outcome prediction regarding the subject in order to assist decision making of a user.

### (Supplementary Note C8)

The information processing program according to any one of Supplementary Notes C1 to C7,
causing the computer to further function as
a learning means for causing the prediction means to perform machine learning referring to training data including a feature vector and a ground truth label attached to the feature vector.

### [Supplementary Note D]

The present disclosure includes the techniques described in the following supplementary notes. However, the present disclosure is not limited to the techniques described in the following supplementary notes, and various modifications can be made within the scope described in the claims.

### (Supplementary Note D1)

An information processing apparatus including at least one processor, in which
the at least one processor executes
acquisition processing of acquiring input data including multivariate time-series data regarding one or a plurality of subjects,
structuring processing of generating structured data by graph structuring of the multivariate time-series data,
calculation processing of calculating a feature vector of the one or the plurality of subjects by referring to at least the structured data, and
prediction processing of performing prediction regarding the subject by referring to the feature vector.

The information processing apparatus may further include a memory. The memory may store a program for causing the at least one processor to execute each type of the processing.

### (Supplementary Note D2)

The information processing apparatus according to Supplementary Note D1, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data, and
feature vector calculation processing of calculating the feature vector of the one or the plurality of subjects by referring to the structured data and the patient graph.

### (Supplementary Note D3)

The information processing apparatus according to Supplementary Note D2, in which
in the feature vector calculation processing, the at least one processor
generates encoded data by encoding the structured data and data included in the patient graph, and
calculates the feature vector of the one or the plurality of subjects by referring to the encoded data.

### (Supplementary Note D4)

The information processing apparatus according to Supplementary Note D1, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data and the structured data, and
feature vector calculation processing of calculating the feature vector of the one or the plurality of subjects by referring to the patient graph.

### (Supplementary Note D5)

The information processing apparatus according to any one of Supplementary Notes D2 to D4, in which
in the structuring processing, the at least one processor
generates, as the structured data, a graph including
nodes respectively corresponding to a plurality of data values included in the multivariate time-series data, and
an edge weighted according to a time difference between the plurality of data values.

### (Supplementary Note D6)

The information processing apparatus according to Supplementary Note D5, in which in the feature vector calculation processing, the at least one processor calculates the feature vector of the one or the plurality of subjects by executing embedding propagation referring to at least the patient graph.

### (Supplementary Note D7)

The information processing apparatus according to any one of Supplementary Notes D1 to D6, in which in the prediction processing, the at least one processor performs outcome prediction regarding the subject in order to assist decision making of a user.

### (Supplementary Note D8)

The information processing apparatus according to any one of Supplementary Notes D1 to D7, in which
the at least one processor further executes
learning processing of causing the prediction processing to perform machine learning referring to training data including a feature vector and a ground truth label attached to the feature vector.

### [Supplementary Note E]

The present disclosure includes the techniques described in the following supplementary notes. However, the present disclosure is not limited to the techniques described in the following supplementary notes, and various modifications can be made within the scope described in the claims.

### (Supplementary Note E1)

A non-transitory recording medium storing an information processing program for causing a computer to function as an information processing apparatus,
the information processing program causing the computer to execute
acquisition processing of acquiring input data including multivariate time-series data regarding one or a plurality of subjects,
structuring processing of generating structured data by graph structuring of the multivariate time-series data,
calculation processing of calculating a feature vector of the one or the plurality of subjects by referring to at least the structured data, and
prediction processing of performing prediction regarding the subject by referring to the feature vector.

What is claimed is:

1. An information processing apparatus including at least one processor and at least one memory, in which
the at least one processor executes;
acquisition processing of acquiring input data including multivariate time-series data regarding one or a plurality of subjects,
structuring processing of generating structured data by graph structuring of the multivariate time-series data,
calculation processing of calculating a feature vector of the one or the plurality of subjects by referring to at least the structured data, and
prediction processing of performing prediction regarding the subject by referring to the feature vector,
the at least one memory may store a program for causing the at least one processor to execute each type of the processing.

2. The information processing apparatus according to claim 1, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data, and
feature vector calculation processing of calculating the feature vector of the one or the plurality of subjects by referring to the structured data and the patient graph.

3. The information processing apparatus according to claim 2, in which
in the feature vector calculation processing, the at least one processor
generates encoded data by encoding the structured data and data included in the patient graph, and
calculates the feature vector of the one or the plurality of subjects by referring to the encoded data.

4. The information processing apparatus according to claim 1, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data and the structured data, and
feature vector calculation processing of calculating the feature vector of the one or the plurality of subjects by referring to the patient graph.

5. The information processing apparatus according to claim 2, in which
in the structuring processing, the at least one processor
generates, as the structured data, a graph including
nodes respectively corresponding to a plurality of data values included in the multivariate time-series data, and
an edge weighted according to a time difference between the plurality of data values.

6. The information processing apparatus according to claim 5, in which in the feature vector calculation processing, the at least one processor calculates the feature vector of the one or the plurality of subjects by executing embedding propagation referring to at least the patient graph.

7. The information processing apparatus according to claim 1, in which in the prediction processing, the at least one processor performs outcome prediction regarding the subject in order to assist decision making of a user.

8. The information processing apparatus according to claim 1, in which
the at least one processor further executes
learning processing of causing the prediction processing to perform machine learning referring to training data including a feature vector and a ground truth label attached to the feature vector.

9. An information processing method including
acquisition processing of acquiring input data including multivariate time-series data regarding one or a plurality of subjects, by at least one processor,
structuring processing of generating structured data by graph structuring of the multivariate time-series data, by the at least one processor,
calculation processing of calculating a feature vector of the one or the plurality of subjects by referring to at least the structured data, by the at least one processor, and
prediction processing of performing prediction regarding the subject by referring to the feature vector, by the at least one processor.

10. The information processing method according to claim 9, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data, and
feature vector calculation processing of calculating the feature vector of the one or the plurality of subjects by referring to the structured data and the patient graph.

11. The information processing method according to claim 10, in which
in the feature vector calculation processing, the at least one processor
generates encoded data by encoding the structured data and data included in the patient graph, and
calculates the feature vector of the one or the plurality of subjects by referring to the encoded data.

12. The information processing method according to claim 9, in which
the input data includes attribute data of the one or the plurality of subjects, and
in the calculation processing, the at least one processor executes
patient graph generation processing of generating a patient graph including, as nodes, a plurality of patients including the one or the plurality of subjects, by referring to the attribute data and the structured data, and
feature vector calculation processing of calculating the feature vector of the one or the plurality of subjects by referring to the patient graph.

13. The information processing method according to claim 10, in which
in the structuring processing, the at least one processor
generates, as the structured data, a graph including
nodes respectively corresponding to a plurality of data values included in the multivariate time-series data, and
an edge weighted according to a time difference between the plurality of data values.

14. The information processing method according to claim 13, in which in the feature vector calculation processing, the at least one processor calculates the feature vector of the one or the plurality of subjects by executing embedding propagation referring to at least the patient graph.

15. The information processing method according to claim 9, in which in the prediction processing, the at least one processor performs outcome prediction regarding the subject in order to assist decision making of a user.

16. The information processing method according to claim 9, further including learning processing of causing the prediction processing to perform machine learning referring to training data including a feature vector and a ground truth label attached to the feature vector, by the at least one processor.

17. A non-transitory recording medium storing an information processing program for causing a computer to function as an information processing apparatus,
the information processing program causing the computer to execute
acquisition processing of acquiring input data including multivariate time-series data regarding one or a plurality of subjects,
structuring processing of generating structured data by graph structuring of the multivariate time-series data,
calculation processing of calculating a feature vector of the one or the plurality of subjects by referring to at least the structured data, and
prediction processing of performing prediction regarding the subject by referring to the feature vector.

18. The non-transitory recording medium according to claim 17, in which
the input data includes attribute data of the one or the plurality of subjects, and
the calculation means executes
patient graph generation processing of generating a patient graph including, as nodes, a plurality of patients including the one or the plurality of subjects, by referring to the attribute data, and
feature vector calculation processing of calculating the feature vector of the one or the plurality of subjects by referring to the structured data and the patient graph.

19. The non-transitory recording medium according to claim 18, in which
the feature vector calculation means
generates encoded data by encoding the structured data and data included in the patient graph, and
calculates the feature vector of the one or the plurality of subjects by referring to the encoded data.

20. The non-transitory recording medium according to claim 17, in which
the input data includes attribute data of the one or the plurality of subjects, and
the calculation means executes
patient graph generation processing of generating a patient graph including, as nodes, a plurality of patients including the one or the plurality of subjects, by referring to the attribute data and the structured data, and
feature vector calculation processing of calculating the feature vector of the one or the plurality of subjects by referring to the patient graph.
